(19) United States
(12) Patent Application Publication
(10) Pub. No.: US 2020/0039423 A1
(43) Pub. Date: Feb. 6, 2020

(54) DOOR-STATUS WARNING LIGHT CIRCUIT

(71) Applicant: WIESON TECHNOLOGIES CO., LTD., New Taipei (TW)

(72) Inventors: Mei-Dong PAN, New Taipei (TW); Chueh-Kuang CHAN, New Taipei (TW)

(21) Appl. No.: 16/050,632

(22) Filed: Jul. 31, 2018

(51) Int. Cl. B60Q 1/32; H05B 33/08

(52) U.S. Cl. CPC B60Q 1/323; H05B 33/0854; B60Q 3/80; H05B 33/0818; H05B 33/0872

(57) ABSTRACT

A door-status warning light circuit includes a first light group capable of emitting light with high brightness or specific warning color and a second light group capable of emitting light with low brightness or specific safe color, and when any door of a fire truck or an ambulance is opened, the first light group can emit light with high brightness and the warning color to remind the driver that a door is not closed; and, after all doors are closed, the first light group lights off and the second light group lights up, so as to inform, by light with different brightness or different color, the driver that all doors are closed, thereby effectively reminding the driver of the door status of the vehicle in noisy environment.

### BACKGROUND OF THE INVENTION

### 1. Field of the Invention

The present invention generally relates to a door-status warning light circuit, more particularly a door status warning device for special function vehicle or special occasion.

### 2. Description of the Related Art

Automobiles have become an important means of transportation in any country for carrying people or the goods. It is easy for a user to operate an automobile, and the user just needs to control the steering wheel, the gear shifter, the accelerator and the brake of the automobile for driving the automobile upon the will thereof. Because of the easy operation and high carrying capacity of the automobile, various types of automobiles with special functions are developed, such as trucks, ambulances, fire trucks, and so on, thereby solving people's various problems in life or work.

However, easy operation of the automobile is likely to cause the driver's negligence. For example, it is common knowledge that the automobile should not be driven to move until all doors of the automobile are completely closed; otherwise, the door not completely closed may be fully opened subject to the wind pressure or the inertia of gravity during traveling of the automobile, and the opened door can easily cause the danger of an adjacent motor vehicle or a passerby. Generally, in order to remind the driver, a door-status warning light is disposed on the dashboard, and the door-status warning light does not light off until all doors of the automobile are closed; furthermore, a prompt sound indicative of one of the doors not closed is also used to remind the driver to close the opened door. The way of using door-status warning in cooperation with the prompt sound can exert reminding effect for car drivers. However, for fire trucks or ambulances, because of the tension of starting to relief disaster and the need to whistle for informing passers-by to dodge, the loud whistle sound causes the driver hardly to hear the prompt sound indicative of the door not closed, and the driver may also ignore the prompt light with weak brightness on the dashboard. Therefore, what is needed is to develop a door-status warning light circuit for the special function automobile.

### SUMMARY OF THE INVENTION

In order to solve the conventional problems, the inventor develops a door-status warning light circuit according to collected data, years of experience, and multiple tests and modifications.

According to an embodiment, the present invention provides a door-status warning light circuit and a warning method thereof. The door-status warning light circuit includes a first light group configured to emit warning light with high brightness or specific warning color, and a second light group configured to emit soft light with low brightness or specific safe color; and, when any door of a fire truck or an ambulance is opened, the first light group emits the warning light with high brightness and warning color to remind a driver that the door is not closed; and, when all doors of the fire truck or the ambulance are closed, the first light group lights off, and the second light group is switched to light up, so as to inform, by the light with different brightness or different color, the driver that all doors are closed, thereby using different brightness or different color of light to effectively remind the driver of the door status of the vehicle in noisy environment.

According to an embodiment, the present invention provides a door-status warning light circuit which has a small size and can be mounted inside the vehicle easily; and, when the door of the vehicle is closed, the driver can operate the switch to light up the first light group or the second light group, or light off both of the first light group and the second light group, so as to provide the driving environment with different brightness and different color for illumination, or the driving environment without illumination, thereby meeting the driver's requirement in illumination.

### BRIEF DESCRIPTION OF THE DRAWINGS

FIG. 1 is a schematic view of a door-status warning light circuit of a first embodiment of the present invention.

FIG. 2 is a schematic view of a door-status warning light circuit of a second embodiment of the present invention.

FIG. 3 is a flow chart of a door status warning method of an embodiment of the present invention.

FIG. 4 is a detailed circuit view of the circuit shown in FIG. 1.

FIG. 5 is a detailed circuit view of the circuit shown in FIG. 2.

### DETAILED DESCRIPTION OF THE PREFERRED EMBODIMENTS

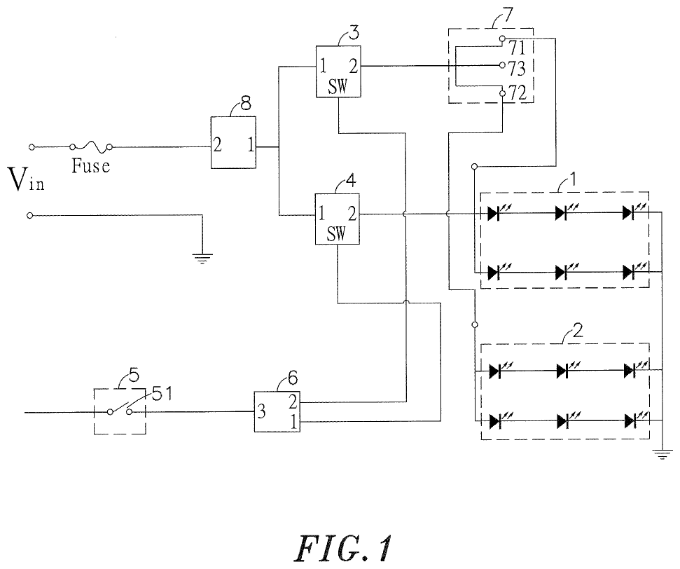

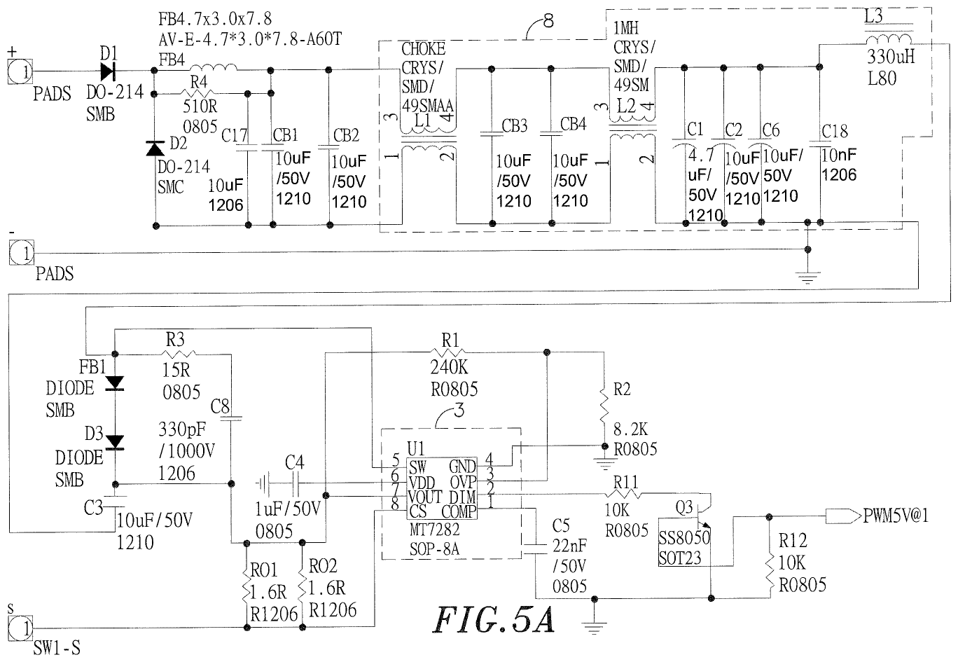

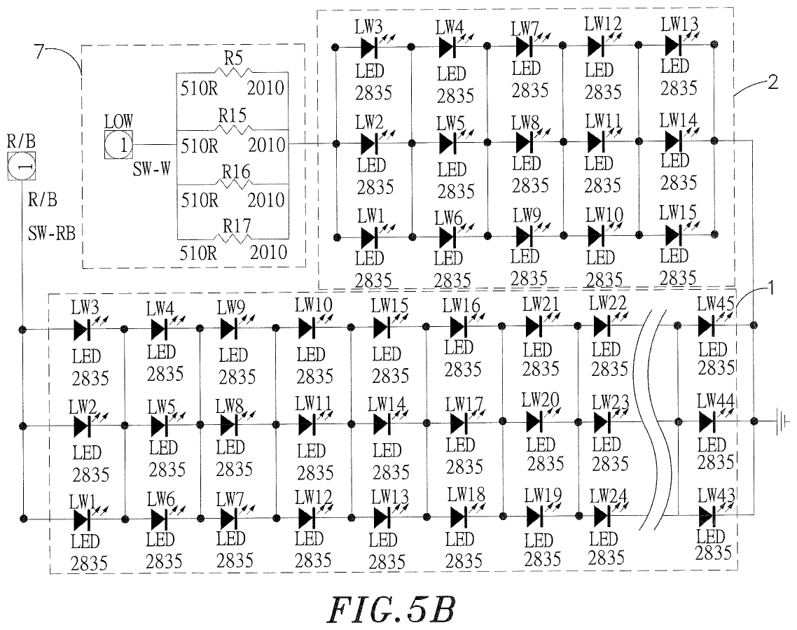

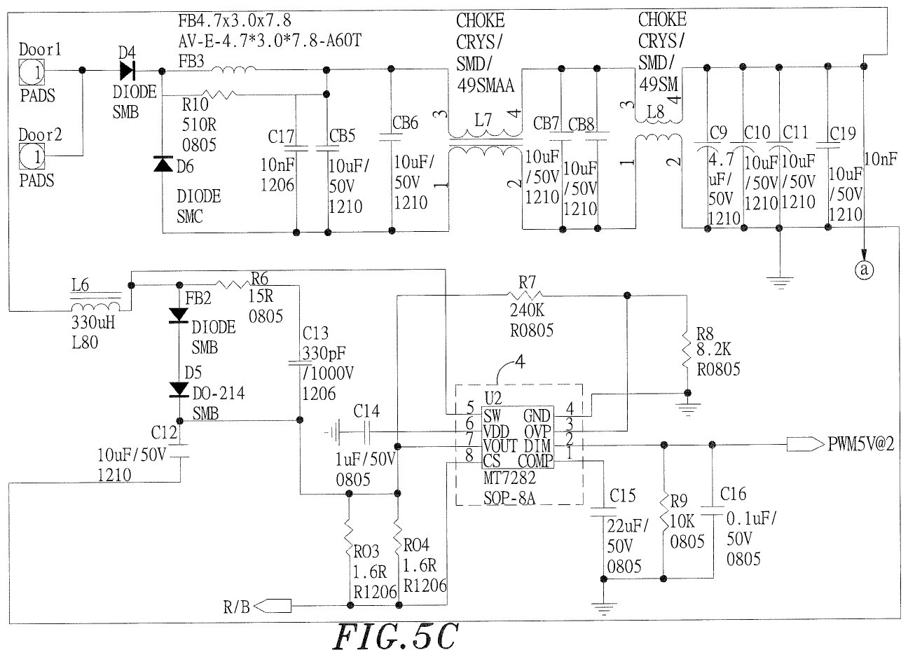

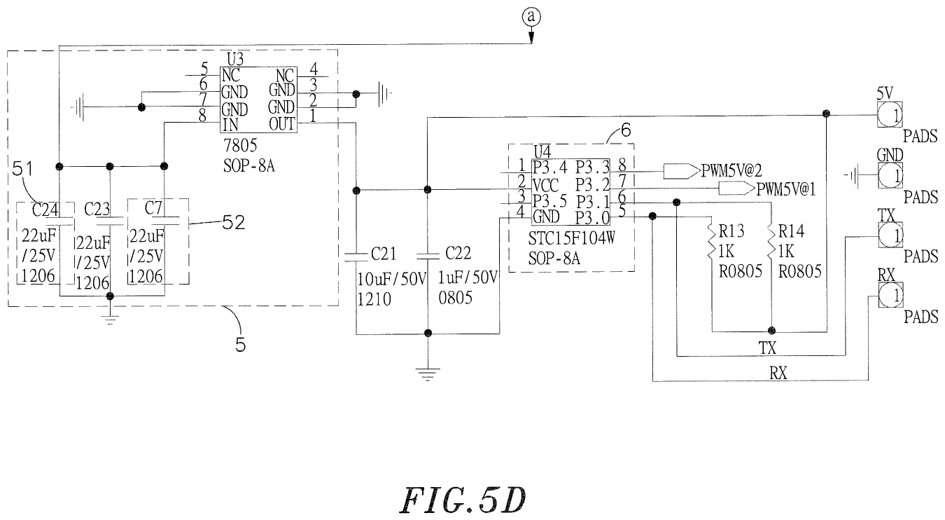

Please refer to FIGS. 1, 2, 4 and 5, which are schematic views and detailed circuit views of a door-status warning light circuit of a first embodiment and a second embodiment of the present invention, respectively. As shown in FIG. 1, the door-status warning light circuit comprises a first light group 1, a second light group 2, a first driving unit 3, a second driving unit 4, a control switch group 5, a micro control unit 6, a switch 7, and an electromagnetic compatibility processing unit 8. The electrical connection relationship between the electronic components is described below.

The first light group 1 is configured to emit warning light with high brightness or specific warning color.

The second light group 2 is configured to emit soft light with low brightness or specific safe color.

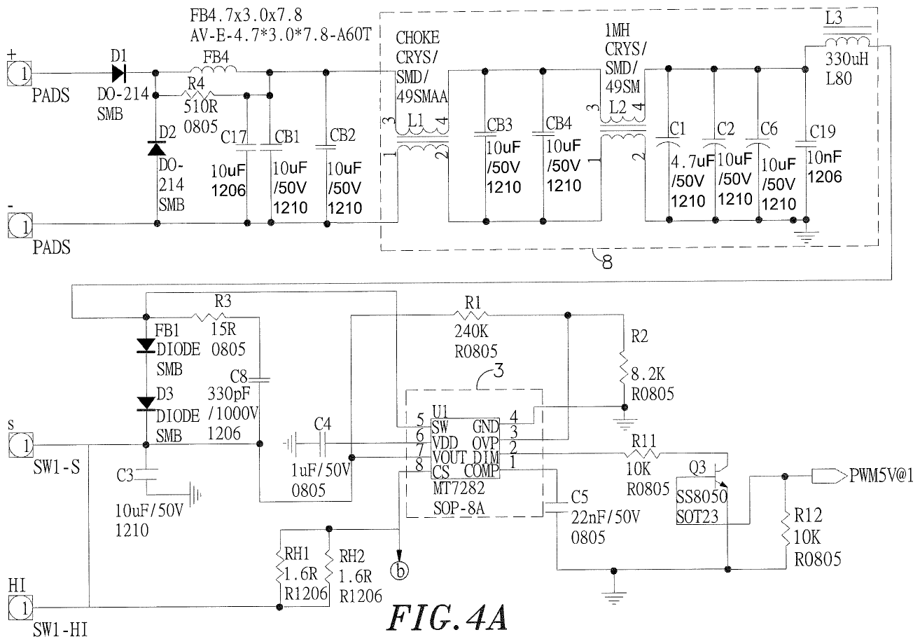

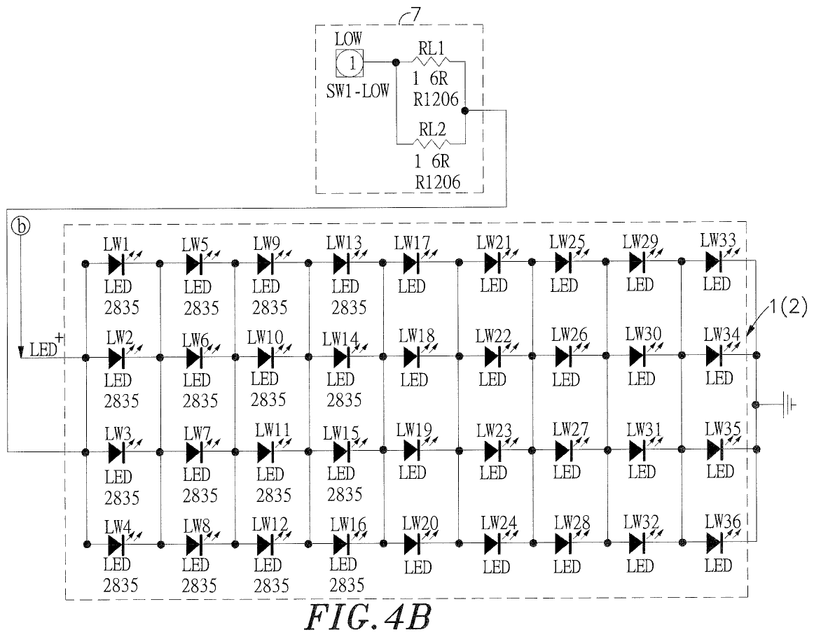

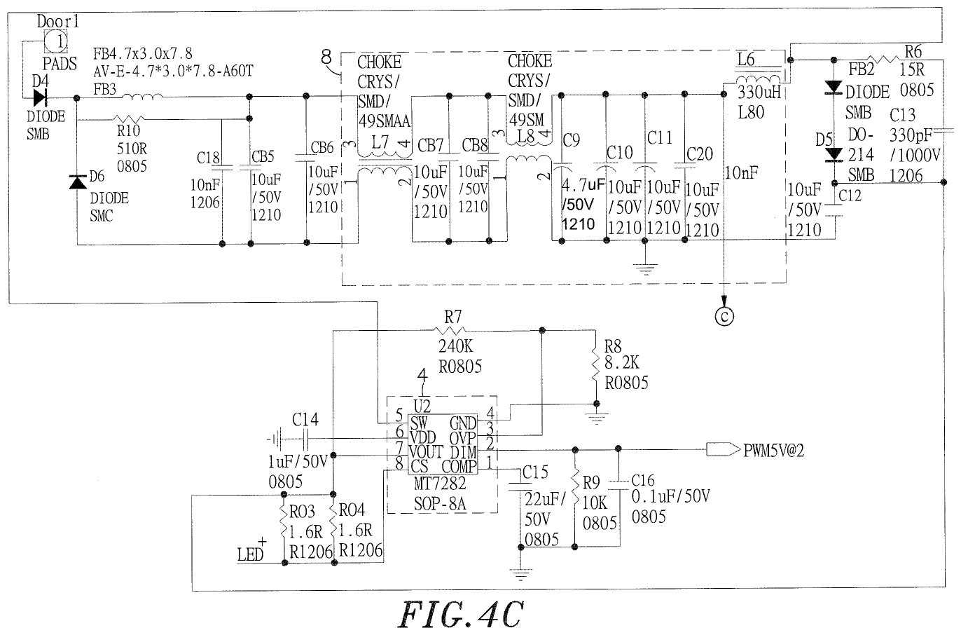

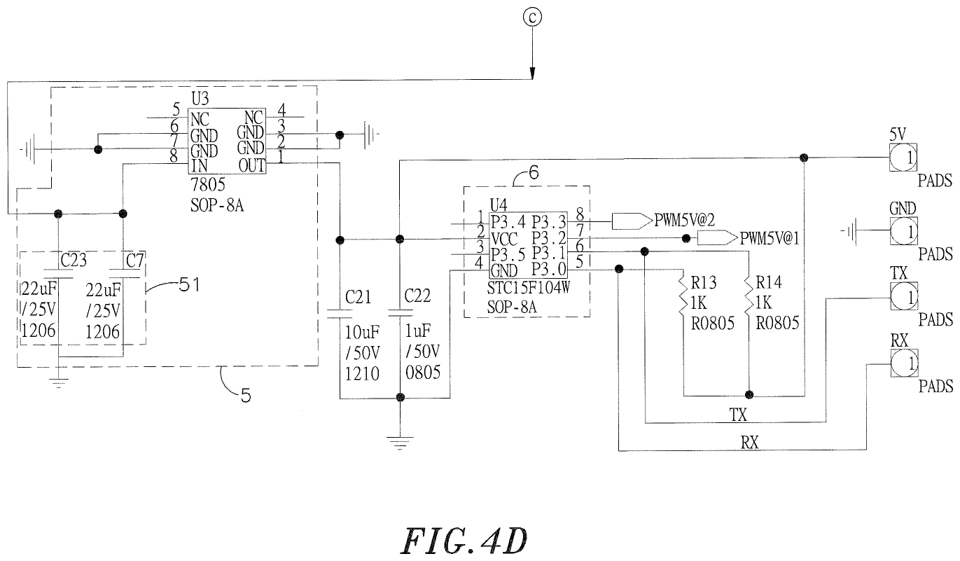

As shown in FIG. 1, in the first embodiment, the warning light with the specific warning color can be white light with high brightness, and the soft light with the specific safe color can be white light with low brightness. As shown in the detailed circuit view shown in FIG. 4, the first light group 1 and the second light group 2 have the same structures and components, and are shareable to each other. When one of the light groups receives the current controlled by high-power PWM, the light group becomes the first light group 1 emitting white light with high brightness for purpose of warning; on the other hand, when one of the light groups receives the current controlled by low-power PWM, the light group becomes the second light group 2 emitting white light with low brightness for purpose of illumination.

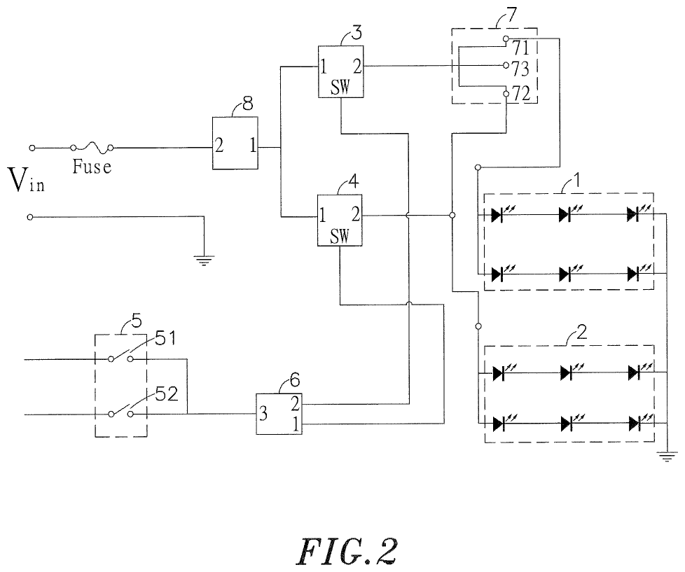

As shown in FIG. 2, in the second embodiment, the warning light with the specific warning color emitted from the first light group 1 can be red or blue light, and this color light with the high brightness is for warning; and, in other embodiment, the persons skilled in the art can apply other color light with warning effect without departing from the spirit and scope of the disclosure set forth in the claims. The soft light with the specific safe color emitted from the second light group 2 can be white light for illumination; and, in other embodiment, the persons skilled in the art can apply other soft light color (such as yellow or blue) with illumination effect without departing from the spirit and scope of the disclosure set forth in the claims.

Each of the first light group 1 and the second light group 2 can comprise a plurality of light emitting diodes (LEDs) which are arranged in a square or rectangular structure; and, in other embodiment, the persons skilled in the art can arrange the plurality of LEDs in other geometrical pattern, without departing from the spirit and scope of the disclosure set forth in the claims.

The first driving unit 3 is electrically connected to a power terminal Vin in series, and configured to drive the first light group 1 and the second light group 2. The switch 7 can be disposed between the first driving unit 3, the first light group 1 and the second light group 2, and the switch 7 comprises a contact for the first light group 71, a contact for the second light group 72, and a switch-off contact 73 which are used to switch operations of lighting up the first light group 1 or the second light group 2, or lighting off both of the first light group and the second light group, respectively.

The second driving unit 4 is electrically connected to the power terminal Vin in series, and electrically connected to the first driving unit 3 in parallel, and configured to drive the first light group 1.

When a door (not shown in figures) of the vehicle is opened, the control switch group 5 is switched on; and, when all doors of the vehicle are closed, the control switch group 5 is switched off. In an embodiment, the control switch group 5 can comprise a first control switch 51 and a second control switch 52, as shown in FIG. 2; or, the control switch group 5 can comprise the first control switch 51 only, as shown in FIG. 1. The persons skilled in the art can dispose more than two control switch groups 5 corresponding to the number of the doors of the vehicle, without departing from the spirit and scope of the disclosure set forth in the claims.

The micro control unit 6 is configured to monitor the control switch group 5 and the door status of the vehicle, and control the operations of the first driving unit 3 or the second driving unit 4. The micro control unit 6 controls the first driving unit 3 or the second driving unit 4 by using pulse width modulation (PWM). Preferably, an amplitude of a waveform of the PWM output from the micro control unit 6 can be 5V, and a frequency of the waveform of the PWM can be 42 KHz.

The electromagnetic compatibility processing unit 8 can be disposed between the power terminal Vin, the first driving unit 3 and the second driving unit 4, and configured to prevent electromagnetic interference (EMI) and provide electromagnetic susceptibility (EMS) function. EMI is caused by electromagnetic field generated by voltage or current, and the electromagnetic susceptibility is the effect of protecting the electronic product from being affected by external electromagnetic environment. The electromagnetic compatibility processing unit 8 disposed in the door-status warning light circuit can filter out unnecessary noise and electromagnetic wave, so as to ensure normal operation of the door-status warning light circuit. In an embodiment, a fuse (label Fuse in FIG. 1) can be disposed between the power terminal Vin and the electromagnetic compatibility processing unit 8, so as to ensure that the fuse can be melt by excessively-high current of the power terminal Vin, thereby protecting all electronic components of the door-status warning light circuit from being burn down.

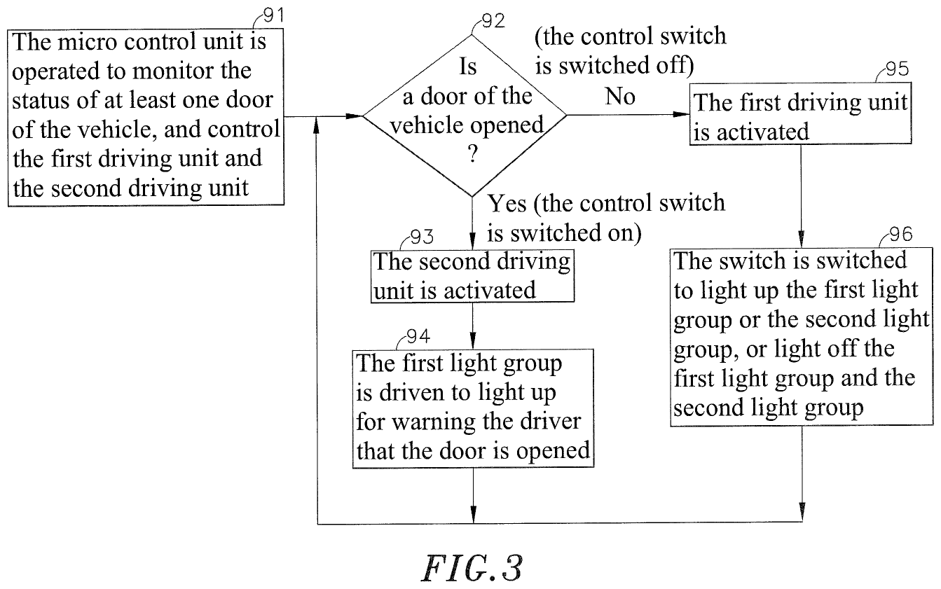

Please refer to FIG. 3, which is a flow chart of a door-status warning method of the present invention. The method includes following steps 91 to 96.

In step 91, the micro control unit is operated to monitor the status of at least one door of the vehicle, and control the first driving unit and the second driving unit.

In step 92, the micro control unit determines whether a door of the vehicle is opened, and when the micro control unit determines that the vehicle door is opened, the control switch is switched on, and the step 93 is performed. In general, a fire truck or ambulance usually comprises two doors, and when at least one of the two doors is opened, the control switch is switched on; and, when the micro control unit determines that no door is opened, the control switch is switched off, and the step 95 is performed.

In step 93, the second driving unit is activated, and the first driving unit is not activated.

In step 94, the first light group is driven to light up for warning the driver that the door is opened, and the step 92 is performed.

In step 95, the first driving unit is activated, and when all doors of the vehicle are closed, the control switch group is switched off, so the micro control unit is not supplied with power and the second driving unit is not activated.

In step 96, the switch is switched to light up the first light group or the second light group, or light off the first light group and the second light group, and the step 92 is performed. No matter the switch is switched to which location, when one door of the vehicle is detected to be opened, the second driving unit is activated to light up the first light group, so as to ensure well operation of the door status warning light.

In summary, the main concept of the present invention is to provide the door-status warning light circuit and the warning method thereof, to control the first light group capable of lighting with high brightness or the specific warning color, and control the second light group capable of lighting with low brightness or the specific safe color, so that when any vehicle door of the fire truck or the ambulance is opened, the first light group can emit light with high brightness or the warning color to remind the driver that the vehicle door is not closed; and, after all doors are closed, the first light group lights off and the second light group lights up, so as to inform the driver that all doors are closed. As a result, the way of using light with different brightness or different color can effectively remind the driver of the door status of the vehicle in noisy environment. Furthermore, the door-status warning light circuit of the present invention has small size and can be mounted inside the vehicle easily; and when the vehicle doors are closed, the driver can operate the switch to light up the first light group or the second light group, or light off the first light group and the second light group, so as to produce the driving environment with different brightness or different color for illumination, or the driving environment without illumination, thereby meeting the driver's requirement in illumination.

The present invention disclosed herein has been described by means of specific embodiments. However, numerous modifications, variations and enhancements can be made thereto by those skilled in the art without departing from the spirit and scope of the disclosure set forth in the claims.

What is claimed is:

1. A door-status warning light circuit, comprising:
a first light group configured to emit warning light with high brightness or specific warning color;
a second light group configured to emit soft light with low brightness or specific safe color;
a first driving unit electrically connected to a power terminal in series, and configured to drive the first light group and the second light group;
a second driving unit electrically connected to the power terminal in series, and electrically connected to the first driving unit in parallel, and configured to drive the first light group;
a control switch group, wherein when a vehicle door is opened, the control switch group is switched on, and when the vehicle door is closed, the control switch group is switched off; and
a micro control unit configured to monitor the control switch group and a status of the vehicle door, and control operation of the first driving unit or the second driving unit.

2. The door-status warning light circuit according to claim 1, wherein the micro control unit controls the first driving unit or the second driving unit by using pulse width modulation (PWM).

3. The door-status warning light circuit according to claim 2, wherein an amplitude of a waveform of the PWM output from the micro control unit is 5V, and a frequency of the waveform of the PWM is 42 KHz.

4. The door-status warning light circuit according to claim 1, further comprising a switch disposed between the first driving unit, the first light group and the second light group, and configured to light up the first light group or the second light group, or light off both of the first light group and the second light group.

5. The door-status warning light circuit according to claim 1, further comprising an electromagnetic compatibility processing unit electrically connected between the power terminal, the first driving unit and the second driving unit.

6. The door-status warning light circuit according to claim 1, wherein each of the first light group and the second light group comprises a plurality of light emitting diodes (LEDs).

7. The door-status warning light circuit according to claim 1, wherein the warning light emitted from the first light group is red light or blue light, and the soft light emitted from the second light group is white light.

8. The door-status warning light circuit according to claim 1, wherein the control switch group comprise a first control switch and a second control switch.
